(19) United States
(12) Patent Application Publication
(10) Pub. No.: US 2009/0072946 A1
(43) Pub. Date: Mar. 19, 2009

(54) COLLABORATIVE PRODUCT AUTHENTICATION

(75) Inventors: Felix Graf von Reischach, Zurich (CH); Florian Michahelles, Zurich (CH)

Correspondence Address: FISH & RICHARDSON, P.C., PO BOX 1022, MINNEAPOLIS, MN, 55440-1022, US

(73) Assignee: SAP AG

(21) Appl. No.: 11/855,797

(22) Filed: Sep. 14, 2007

(51) Int. Cl. G05B 19/00

(52) U.S. Cl. 340/5.8

(57) ABSTRACT

An identification of an RFID tag is received from a mobile device. A product associated with the identification is identified, and a keeper associated with the product is identified. The keeper is provided to the mobile device, and a selection of the keeper is received from the mobile device. Authentication information associated with the product and the keeper is identified, and the authentication information is provided to the mobile device.

### BACKGROUND

The disclosure relates to information retrieval.

With the globalization of production and trade, counterfeiting of products has become a serious problem. Product authentication plays an important role in the fight against counterfeiting. Product authentication denotes the verification of the identity an object claims to have, i.e., it gives an answer (yes/no) to the question if a product is genuine or counterfeit. There are currently a range of approaches to authenticate products. They comprise direct authentication, authentication based on difficult to reproducible features, verification of unique identifiers, plausibility checks of track, and secure object authentication.

### SUMMARY

Disclosed herein are systems, apparatus and methods for authenticating a product. In one implementation, an identification of an RFID tag is received from a mobile device. A product associated with the identification is identified, and a keeper associated with the product is identified. The keeper is provided to the mobile device, and authentication information associated with the product is received from the mobile device. The authentication information is associated with the product and the keeper, and the authentication information is evaluated.

In another implementation, an identification of an RFID tag is received from a mobile device. A product associated with the identification is identified, and a keeper associated with the product is identified. The keeper is provided to the mobile device, and a selection of the keeper is received from the mobile device. Authentication information associated with the product and the keeper is identified, and the authentication information is provided to the mobile device.

In another implementation, an identification of an RFID tag associated with a product is received, and the identification is provided to a product authentication system. A keeper associated with the product based on the identification is received. In response to receiving the keeper, a selection of authentication information associated with the product is received, and the authentication information associated with the product is provided to the product authentication system.

In another implementation, an identification of an RFID tag associated with a product is received, and the identification is provided to a product authentication system. A keeper associated with the product based on the identification is received, and in response to receiving a selection of the keeper, authentication information associated with the product is received and displayed.

### BRIEF DESCRIPTION OF THE DRAWINGS

FIG. 1 is a block diagram of an implementation of a product authentication system.

FIG. 2 is a flow diagram of an example process for receiving authentication information associated with a product.

FIG. 3 is a flow diagram of an example process for receiving authentication information associated with a product.

FIG. 4 is a flow of an example process for providing authentication information associated with a product.

FIG. 5 is a flow of an example process for providing authentication information associated with a product.

FIG. 6 is a block diagram of an example implementation of the mobile device of FIG. 1.

FIG. 7 is a schematic diagram of an example computer system that can be utilized to implement the systems and methods described herein.

### DETAILED DESCRIPTION

The drawbacks of the existing approaches in combination with the developments in technology lead to the demand for a new approach for product authentication. The advantages of communities and direct authentication through users, such as experts, are leveraged.

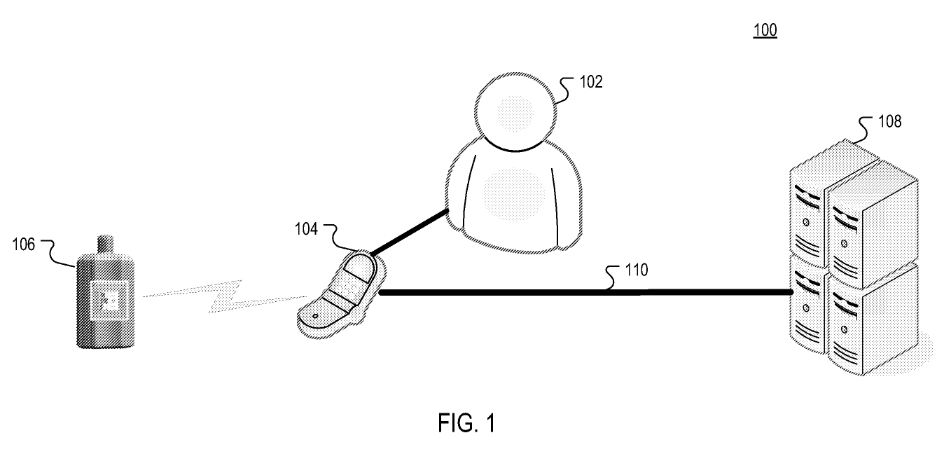

FIG. 1 is a block diagram of an implementation of a collaborative authentication system 100. A computer network 110, such as a local area network (LAN), wide area network (WAN), the Internet, or a combination thereof, connects a user 102, a mobile device 104, and a product authentication system 108. The product authentication system 108 can, for example, be an identification engine. The identification engine can performs all the tasks of the authentication engine 108.

In one implementation, communities are determined through user 102 contribution and benefit from the communities. Contributing to the community, the users 102 authenticate products 106 based on their knowledge about a particular product. Benefiting from the community, users 102 receive the authentication information about products 106 that was provided by the users 102 previously.

In one implementation, the collaborative authentication system 100 can gather information from one or more users 102 regarding the authenticity of products 106. The information can be stored and used by others users 102 when determining whether a product 106 is counterfeit or genuine. In another implementation, one or more users 102 can determine whether a product 106 is genuine or counterfeit using the collaborative authentication system 100.

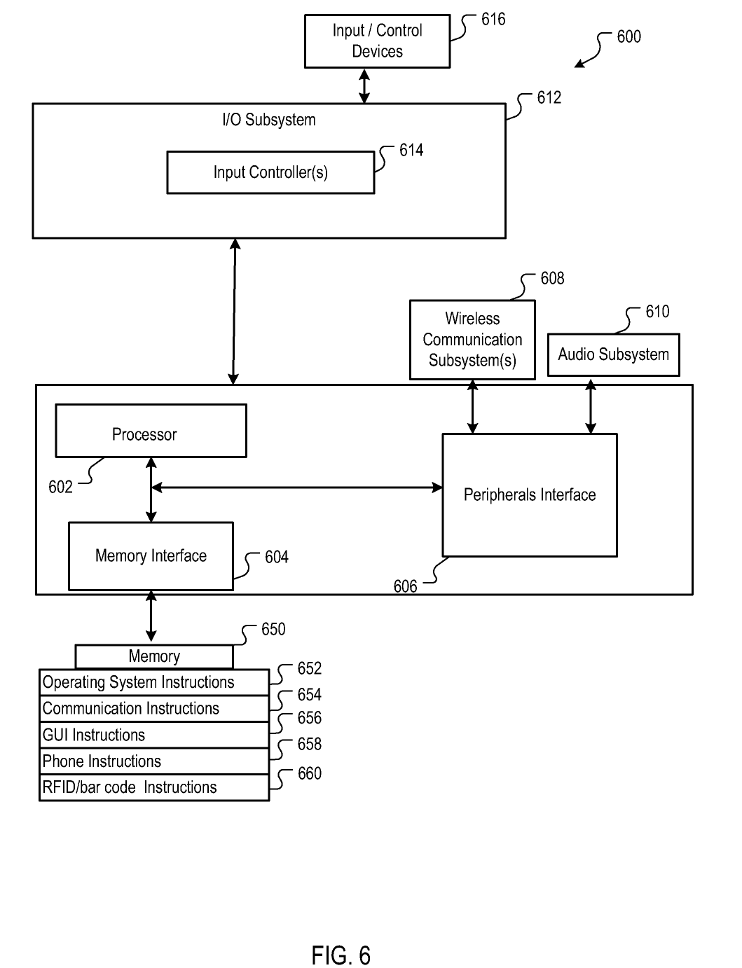

The mobile device 104 can be, for example, be a handheld computer, a personal digital assistant, a cellular telephone, a camera, a smart phone, a media player, a navigation device, an email device, a game console, or a combination of these data processing devices or other data processing devices. The mobile device 104 can also include one or more wireless communication subsystems, such as an 802.11b/g communication device, and/or a Bluetooth™ communication device. Other communication protocols can also be supported, including other 802.x communication protocols (e.g., WiMax, Wi-Fi), code division multiple access (CDMA), W-CDMA or UMTS (3G), global system for mobile communications (GSM), Enhanced Data GSM Environment (EDGE), etc. An example implementation of the mobile device 104 is shown in FIG. 6.

The mobile device 104 can, for example, communicate over one or more wired and/or wireless networks 110 in data communication. In some implementations, the mobile device 104 may include circuitry and sensors for user as a radio frequency identification (FRID) reader. RFID is an automatic identification method, relying on storing and retrieving data through a wireless connection data using devices called RFID tags or transponders. An RFID tag includes integrated circuitry and antennas configured to receive and transmit data to radio frequency queries from an RFID transceiver such as, for example, an RFID reader or scanner. The integrated circuitry may be configured to transmit identification data responsive to a query from a reader device. The RFID reader can be configured to communicate with the system 108 to transmit data.

RFID tags may be attached for purposes of tracking and identification. Each of the products 106, can for example, be attached with an RFID tag. The RFID tag can be programmed with a unique identification code. Additionally, this identification code can be used by the system 108 and the mobile device 104 to identify the product 106. The RFID tags are configured to wirelessly receive a query from the mobile device 104 (RFID reader) and to transmit data in response to the query. The data can include the unique identification code or other identification information such as, for example, product type, serial number, quantity, access level, etc. In one implementation, in the case of the unique identification code, the mobile device 104 synchronizes with the system 108 to determine the identification information associated with the unique identification code.

In one implementation, the authentication is related to a certain “keeper.” The keeper could be a store that sells the product or generally anybody who was keeping the product when it was authenticated by the user 102. This information can be used to warn users, e.g., end-consumers, of certain sellers of counterfeit goods. The detailed processes of contributing to and benefiting from the community are set forth below.

In one implementation, a user 102 can contribute to a community. A user 102 can for example, be in possession of a product 106. For example, the user 102 can be at a merchant shopping for one or more products 106. The user 102 can scan the RFID tag of the product 106 using a mobile device 104. The scanned RFID tag can, for example, be associated with a certain type of product 106.

In one implementation, the mobile device 104 can identify the product 106 based on an identification of the RFID tag. The mobile device 104 can, for example, store a list of products with associated RFID tags. Upon receiving an identification of the RFID tag of the product 106, the mobile device 104 can determine the specific product the user 102 has scanned with the mobile device 104 by comparing the identification of the RFID tag with the list of products and associated RFID tags. The mobile device 104 can send the identified product 106 to the product authentication system 108. For example, the mobile device 102 can send a product identification associated with the product to the product authentication system.

In another implementation, the mobile device 104 can send the identification of the RFID tag to the product authentication system 108. The mobile device 104 can send a tuple of data to the product authentication system. The tuple can, for example, include a product identification, keeper identification, user identification, and timestamp. The product identification can include a name of the product. The keeper identification can include the name of the keeper or a unique number associated with the keeper. The user identification can include a unique number associated with the user, for example, a social security number, or a number selected by the user. The timestamp can include the time the mobile device 104 scanned the product.

In one implementation, the product authentication system 108 can identify the product 106 based on the data received from the mobile device 104. The product authentication system 104 can, for example, identify the product based on the identification of the RFID tag. The product authentication system 108 can, for example, store the list of products with associated identifications of RFID tags. Upon receipt of the identification of the RFID tag of the product 106, the product authentication system 108 can identify the product by comparing the identification of the RFID tag with the list of products and associated identification of RFID tags.

In one implementation, the mobile device 104 can query the product authentication system 108 for assigned keepers for the identified product 106. A keeper can, for example, be a store that sells the product 106 or generally anybody who was keeping the product 106 when it was authenticated by the user 102. The mobile device 104 can, for example, query the product authentication system 108 for all keepers that are associated with the identified product 106.

In one implementation, the product authentication system 108 can compare the identified product with a stored list of keepers and products either sold or associated with the keepers. The system 108 can, therefore, compare the identified product with the list to identify all the keepers associated with the identified product. The product authentication system 108 can provide a list of one or more keepers associated with the identified product 106. The product authentication system 108 can, for example, store a list of products and associated keepers. A product can, for example, be associated with one or more keepers. The product authentication system 108 can provide the keepers to the mobile device 104.

In one implementation, the mobile device 104 can receive the keepers associated with the product 106, and the keepers can be presented to the user 102. The user 102 can, for example, either select one of the keepers form the list provided by the product authentication system 108 or the user 102 can enter a new keeper to associate with the product 106. For example, if the keeper that the product 106 is located at is not in the list of keepers, the user 102 can enter new keeper information using the mobile device 104. The new keeper information can, for example, include the keeper name and location. The mobile device 104 can receive the selection of the keeper from the list, or the new keeper information from the user 102. Having associated the product with the keeper of the product, the user 102 can enter the actual authentication information using the mobile device 104.

The authentication information can, for example, be associated with whether the product is counterfeit or genuine. If the user 102 determines the product is genuine, then the authentication information can reflect the product is genuine. If the user 102 determines the product is counterfeit, then the authentication information can reflect the product is counterfeit. In one implementation, authentication information can also include varying degrees associated with the authenticity of a product 106. For example, the user 102 can select from a range of 1 to 10 when determining the authenticity of a product 106, where 1 is a genuine product and 10 is counterfeit.

In one implementation, the mobile device 104 can provide the authentication information received to the product authentication system 108. The product authentication system 108 can receive the authentication information and can associate the authentication information with the product 106 in accordance with the user 102 authentication and the keeper selected by the user 102. Therefore, the product authentication system 108 can associate for each keeper, the product associated with the keeper as well as the authentication information associated with the product located at the keeper.

In one implementation, the product authentication system 108 can evaluate the authentication information. For example, the product authentication system 108 can evaluate the authentication information based on the status, or experience level, of the user 102. If, for example, experience level of the user 102 reflects the user 102 is an expert user, the product authentication system 108 can rate the authentication information higher than if the user 102 was a beginner user. The experience level associated with the user 102 can, for example, depend on the number of time the user 102 has contributed authentication information to the collaborative authentication system 100. In one implementation, the system 100 can associate an experience level with a user 102 prior to the user 102 contributing authentication information to the system.

In one implementation, the product authentication system 108 can collect authentication information for one or more products 106 from one or more users 102. The authentication information can be distributed to other users 102 upon inquiry about the authenticity of a product, as will be described below.

For example, suppose a user A is shopping in a store A and selects a particular perfume. User A determines the perfume in store A is counterfeit. User A can scan the RFID tag of the perfume with his mobile device. The mobile device can identify the product based on the identification of the RFID tag. The mobile device can, for example, identify the perfume as perfume A based on the RFID tag. The mobile device can provide the product, perfume A, to the product authentication system in order to receive a list of one or more keepers associated with the product. The product authentication system can then provide the mobile device with a list of one or more keepers. The user 102 can scroll through the list of keepers to determine whether store A is one of the keepers. If store A is not one of the keepers, the user can add a new keeper to the list of keepers by entering the name of the keeper (store A) along with other information such as the location of the keeper using the mobile device. If store A is one of the keepers, the user can select the keeper (store A) from the list. The mobile device can then receive authentication information associated with perfume A from the user. The user can, for example, provide that perfume A is counterfeit. The mobile device can provide the authentication information associated with perfume A to the product authentication system. The product authentication system can store the information that perfume A is counterfeit at store A and provide the information to other users that inquire about perfume A at store A at a later time.

In one implementation, a user 102 can determine the authenticity of a product using the collaborative authentication system 100. The user 102 can, for example, scan the RFID tag of a product 106 with a mobile device 104. The mobile device 104 can provide the identification of the RFID tag to the product authentication system 108. Based on the identification, the product authentication system 108 can identify the product the user 102 scanned. The product authentication system 108 can, for example, compare the identification of the RFID tag to a stored list of products with associated RFID tags. Based on the comparison, the product authentication system 108 can identify the product 106.

In one implementation, when the product authentication system 108 receives the selection of the keeper associated with the identified product 106, the product authentication system 108 can provide any authentication information stored associated with the identified product and the selected keeper to the mobile device 104. The mobile device 104 can receive and display the authentication information associated with the product 106.

In another example, suppose a user B in store A wants to determine the authenticity of perfume A. The user can scan the RFID tag of perfume A with a mobile device, and the mobile device can provide the identification of the RFID tag of perfume A to the product authentication system 108. The product authentication system 108 can determine whether any previous users have provided authentication information associated with perfume A at store A. In this example, as described above, the user A provided that perfume A at store A was counterfeit. Therefore, the product authentication system 108 can provide the information received from user A to the mobile device of user B.

In one implementation, if conflicting authentication information is received for a product, the product authentication system 108 can provide all the information to the mobile device 104. For example, the product authentication system 108 can provide the number of users that had authenticated a product as genuine and the number of users that provided that the product was counterfeit.

The product authentication system 108 can be implemented utilizing one or more computing devices that include memory devices storing processing instructions and processing devices for executing the processing instructions. An example computing system is shown and described with reference to FIG. 6. Other implementations, however, can also be used.

While the above implementations refer to products tagged with RFID, products tagged with bar codes can also be authenticated. Instead of an RFID tag, the products can be tagged with a bar code. The mobile device 104 can also be equipped to scan bar codes and transmit bar code information to the product authentication system 108.

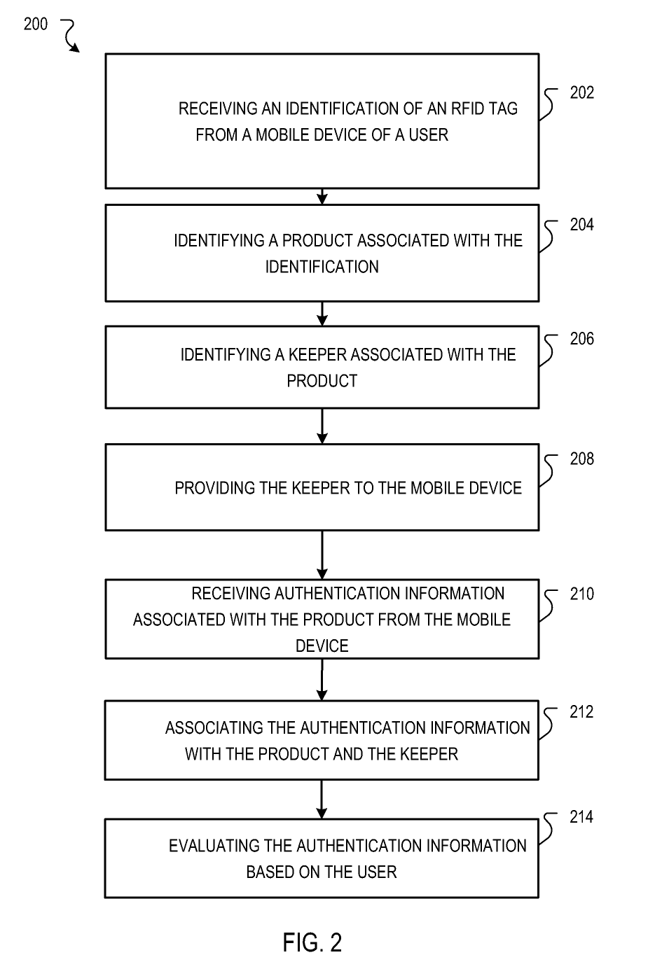

FIG. 2 is a flow diagram of an example process 200 for receiving authentication information associated with a product. The process 200 can, for example, be implemented in a system such as the system 100 of FIG. 1.

Stage 202 receives an identification of an RFID tag from a mobile device. For example, the product authentication system 108 can an identification of an RFID tag from a mobile device 104.

Stage 204 identifies a product associated with the identification. For example, the product authentication system 108 can identify a product 106 associated with the identification.

Stage 206 identifies a keeper associated with the product. For example, the product authentication system 206 can identify a keeper associated with the product 106.

Stage 208 provides the keeper to the mobile device. For example, the product authentication system 206 can provide the keeper to the mobile device 104.

Stage 210 receives authentication information associated with the product from the mobile device. For example, the product authentication system 206 can receive authentication information associated with the product 106 from the mobile device 104.

Stage 212 associates the authentication information with the product and the keeper. For example, the product authentication system 206 can associate the authentication information with the product 106 and the keeper.

Stage 214 evaluates the authentication information. For example, product authentication system 206 can evaluate the authentication information.

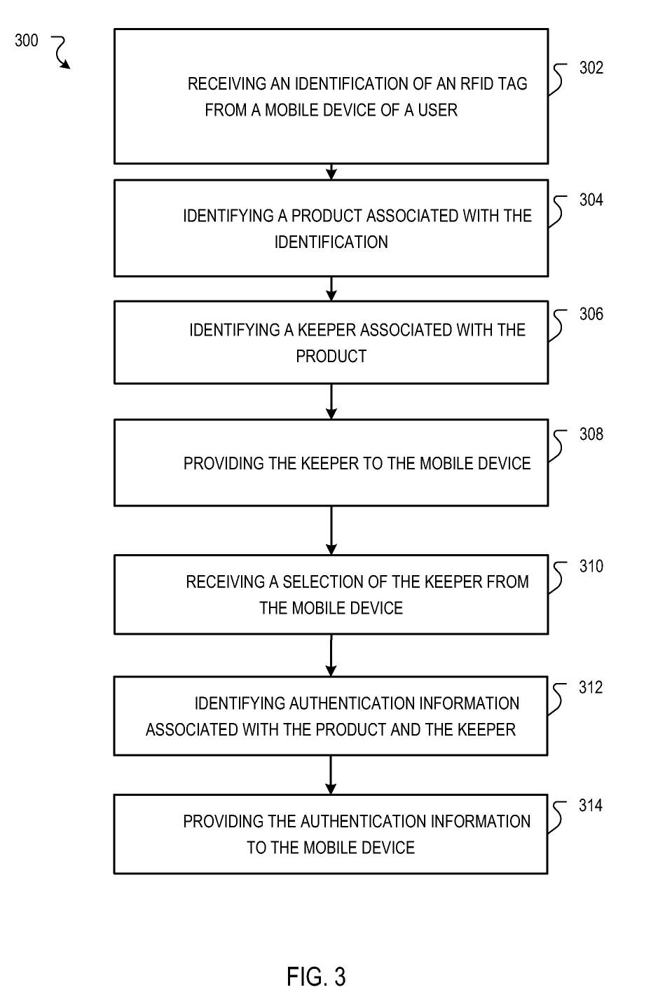

FIG. 3 is a flow diagram of an example process 300 for receiving authentication information associated with a product. The process 300 can, for example, be implemented in a system such as the system 100 of FIG. 1.

Stage 302 receives an identification of an RFID tag from a mobile device. For example, the product authentication system 108 can receive an identification of an RFID tag from a mobile device 104.

Stage 304 identifies a product associated with the identification. For example, the product authentication system 108 can identify a product 106 associated with the identification.

Stage 306 identifies a keeper associated with the product. For example, the product authentication system 108 can identify a keeper associated with the product 106.

Stage 308 provides the keeper to the mobile device. For example, the product authentication system 108 can provide the keeper to the mobile device 104.

Stage 310 receives a selection of the keeper from the mobile device. For example, the product authentication system 108 can receive a selection of the keeper from the mobile device 104.

Stage 312 identifies authentication information associated with the product and the keeper. For example, the product authentication system 108 can identify authentication information associated with the product 106 and the keeper.

Stage 314 provides the authentication information to the mobile device. For example, the product authentication system 108 can provide the authentication information to the mobile device 104.

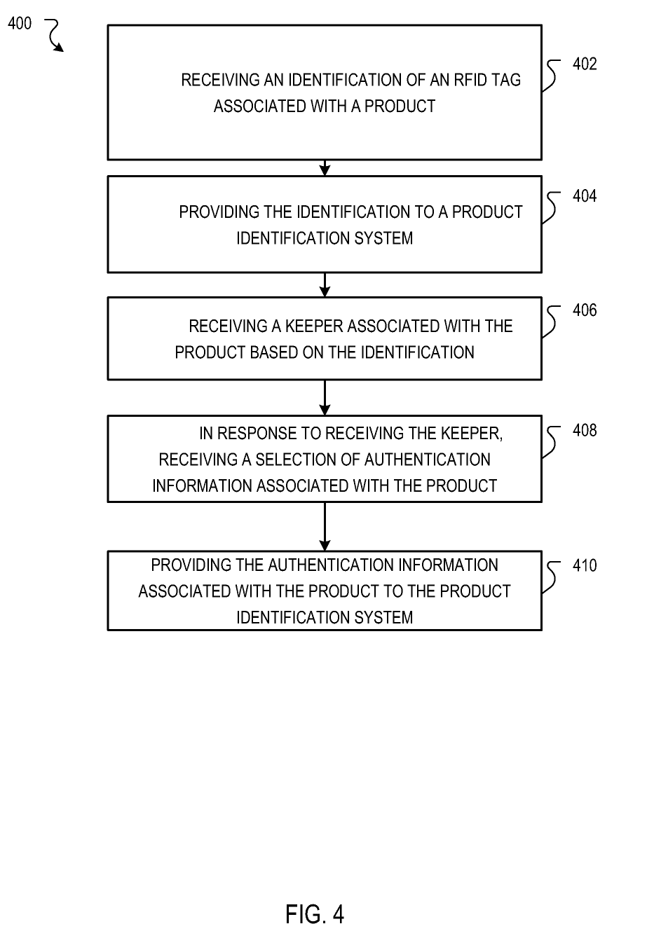

FIG. 4 is a flow of an example process 400 for providing authentication information associated with a product. The process 400 can, for example, be implemented in a system such as the system 100 of FIG. 1.

Stage 402 receives an identification of an RFID tag associated with a product. For example, the mobile device 104 can receive an identification of an RFID tag associated with a product 106.

Stage 404 provides the identification to a product identification system. For example, the mobile device 104 can provide the identification to the product authentication system 108.

Stage 406 receives a keeper associated with the product based on the identification. For example, the mobile device 104 can receive a keeper associated with the product 106 based on the identification.

Stage 408 receives a selection of authentication information associated with the product in response to receiving the keeper. For example, the mobile device 104 can receive a selection of authentication information associated with the product 106 in response to receiving the keeper.

Stage 410 provides the authentication information associated with the product to the product authentication system. For example, the mobile device 104 can provide the authentication information associated with the product 106 to the product authentication system 108.

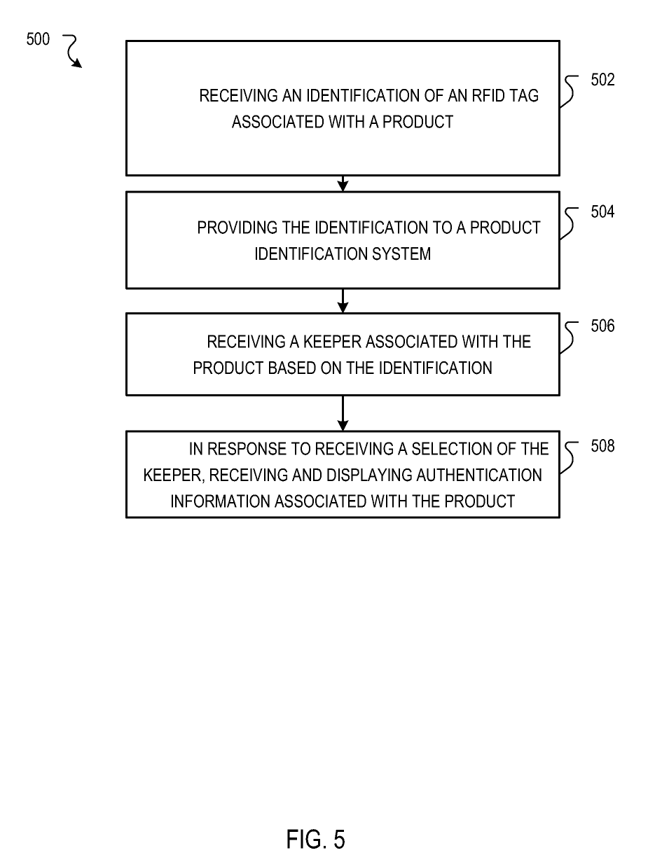

FIG. 5 is a flow of an example process 500 for providing authentication information associated with a product. The process 500 can, for example, be implemented in a system such as the system 100 of FIG. 1.

Stage 502 receives an identification of an RFID tag associated with a product. For example, the mobile device 104 can receive an identification of an RFID tag associated with a product 106.

Stage 504 provides the identification to a product authentication system. For example, the mobile device 104 can provide the identification to a product authentication system 108.

Stage 506 receives a keeper associated with the product based on the identification. For example, the mobile device 104 can receive a keeper associated with the product based on the identification.

Stage 508 receives and displays authentication information associated with the product in response to receiving the selection of the keeper. For example, the mobile device 104 can receive and display authentication information associated with the product in response to receiving the selection of the keeper.

FIG. 6 is a block diagram 600 of an example implementation of the mobile device 104 of FIG. 1. The mobile device 104 can include one or more data processors, image processors and/or central processing units 602, a memory interface 604, and a peripherals interface 606. The one or more processors 602, the memory interface 604, and/or the peripherals interface 606 can be separate components or can be integrated in one or more integrated circuits. The various components in the mobile device 104 can be coupled by one or more communication buses or signal lines.

Sensors, devices and subsystems can be coupled to the peripherals interface 606 to facilitate multiple functionalities. Communication functions can be facilitated with one or more wireless communication subsystems 608, which can include radio frequency receivers and transmitters and/or optical (e.g., infrared) receivers and transmitters. The specific design and implementation of the communication subsystem 608 can depend on the communication network(s) over which the mobile device 104 is intended to operate. For example, a mobile device 104 may include communication subsystems 608 designed to operate over a GSM network, a GPRS network, a Wi-Fi or WiMax network, and a Bluetooth™ network.

An audio subsystem 610 can be coupled to a speaker and a microphone to facilitate voice-enable functions, such as telephony functions. The I/O subsystem 612 can include input controller(s) 614. The input controller(s) 614 can be coupled to input/control devices 616, such as one or more buttons, a touch screen, infrared port, USB port, a bar code reader, an RFID reader, and/or a pointer device such as a stylus.

The memory interface 604 can be coupled to memory 650. The memory 650 can include high-speed random access memory and/or non-volatile memory, such as one or more optical storage devices, one or more magnetic disk storage devices, and/or flash memory. The memory 350 can store an operating system 652, such as LINUX, RTXC, UNIX, OS X, or WINDOWS. The operating system 652 may include instructions for handling basic system services and for performing hardware dependent tasks.

The memory 650 may also store communication instructions 654 to facilitate communicating with one or more additional devices, one or more computers and/or one or more servers. The memory 650 may include graphical user interface instructions 656 to facilitate graphic user interface processing, phone instructions 658 to facilitate phone-related processes and functions, and RFID/bar code instructions 660 to facilitate RFID and bar code related processes and instructions.

Each of the above identified applications and instructions can correspond to a set of instructions for performing one or more functions described above. These instructions need not be implemented as separate procedures, software programs, or modules. The memory 650 can include additional instructions or fewer instructions. Furthermore, various functions of the mobile device 104 may be implemented in hardware and/or in software, including in one or more application specific integrated circuits and/or signal processing.

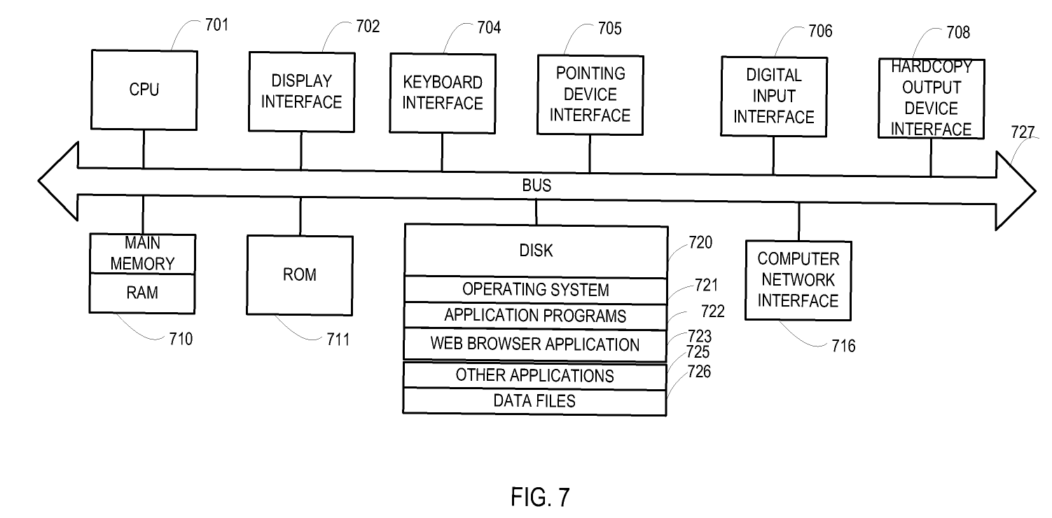

FIG. 7 is a block diagram illustrating the internal architecture of an example computer system. The computing environment includes a computer central processing unit (“CPU”) 701 where the computer instructions that comprise an operating system or an application are processed; a display interface 702 which provides a communication interface and processing functions for rendering graphics, images, and texts on a display monitor; a keyboard interface 704 which provides a communication interface to a keyboard; a pointing device interface 705 which provides a communication interface to a mouse or an equivalent pointing device; a digital input interface 706 which provides a communication interface to a video and audio detector; a hardcopy output device interface 708 which provides a communication interface to a hardcopy output device; a random access memory (“RAM”) 710 where computer instructions and data are stored in a volatile memory device for processing by the computer CPU 701; a read-only memory (“ROM”) 711 where invariant low-level systems code or data for basic system functions such as basic input and output (“I/O”), startup, or reception of keystrokes from a keyboard are stored in a non-volatile memory device; a storage 720 or other suitable type of memory (e.g. such as random-access memory (“RAM”), read-only memory (“ROM”), programmable read-only memory (“PROM”), erasable programmable read-only memory (“EPROM”), electrically erasable programmable read-only memory (“EEPROM”), magnetic disks, optical disks, floppy disks, hard disks, removable cartridges, flash drives), where the files that comprise an operating system 1721, application programs 722 (including web browser application 723, product engine 724, and other applications 725 as necessary) and data files 726 are stored; and a computer network interface 716 which provides a communication interface to a network over a computer network connection. The constituent devices and the computer CPU 701 communicate with each other over the computer bus 727.

The RAM 710 interfaces with the computer bus 727 so as to provide quick RAM storage to the computer CPU 701 during the execution of software programs such as the operating system application programs, and device drivers. More specifically, the computer CPU 701 loads computer-executable process steps from fixed disk drives or other media into a field of the RAM 710 in order to execute software programs. Data is stored in the RAM 710, where the data is accessed by the computer CPU 701 during execution.

Also shown in FIG. 7, the product authentication system 108 can stores computer-executable code for an operating system 721, and application programs 722 such as word processing, spreadsheet, presentation, gaming, web browsing, JavaScript engine, or other applications.

The computer CPU 701 is one of a number of high-performance computer processors, including an INTEL or AMD processor, a POWERPC processor, a MIPS reduced instruction set computer (“RISC”) processor, a SPARC processor, an ACORN RISC Machine (“ARM”) architecture processor, a HP ALPHASERVER processor or a proprietary computer processor for a mainframe. In an additional arrangement, the computer CPU 701 is more than one processing unit, including a multiple CPU configuration found in high-performance workstations and servers, or a multiple scalable processing unit found in mainframes.

The operating system 1721 may be APPLE MAC OS X for INTEL and POWERPC based workstations and servers; MICROSOFTWINDOWS NT®/WINDOWS 2000/WINDOWS XP Workstation; MICROSOFTWINDOWS VISTA/WINDOWS NT/WINDOWS 2000/WINDOWS XP Server; a variety of UNIX-flavored operating systems, including AIX for IBM workstations and servers, SUNOS for SUN workstations and servers, LINUX for INTEL CPU-based workstations and servers, HP UX WORKLOAD MANAGER for HP workstations and servers, IRIX for SGI workstations and servers, VAX/VMS for Digital Equipment Corporation computers, OPENVMS for HP ALPHASERVER-based computers; SYMBIAN OS, NEWTON, IPOD, WINDOWS MOBILE or WINDOWS CE, PALM, NOKIA OS (“NOS”), OSE, or EPOC for mobile devices, or a proprietary operating system for computers or embedded systems. The application development platform or framework for the operating system 1721 may be: BINARY RUNTIME ENVIRONMENT FOR WIRELESS (“BREW”); Java Platform, Micro Edition (“Java ME”) or Java 2 Platform, Micro Edition (“J2ME”); PYTHON™, FLASH LITE, or MICROSOFT .NET Compact.

While FIG. 7 illustrates one possible implementation of a computing system that executes program code, or program or process steps, configured to effectuate product authentication, other types of computers may also be used as well.

While the term “user” has been consistently used to describe an entity that interacts with these processes, such a generalization is also intended to describe multiple related or unrelated, living or automated entities or beings that interact with these processes at various different, overlapping or non-overlapping states. In a similar vein, the term “selection” is intended to denote throughout a manual selection by a human, an automatic selection by a non-human, or some combination thereof.

Finally, it is noted that, for the sake of brevity, the term “JavaScript” is intended to reference the SUN MICROSYSTEMS JAVASCRIPT programming language, and the term “XML” is intended to reference ‘eXtensible Markup Language’ throughout.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method, comprising:
receiving an identification of an RFID tag from a mobile device;
identifying a product associated with the identification;
identifying a keeper associated with the product;
providing the keeper to the mobile device;
receiving authentication information associated with the product from the mobile device, wherein the authentication information includes whether the product is genuine or counterfeit;
associating the authentication information with the product and the keeper; and
evaluating the authentication information.

2. The method of claim 1, wherein the identification of an RFID tag is received by a scan of the RFID tag by the mobile device.

3. The method of claim 1, wherein the keeper is one of a merchant that sells the product or a merchant that stores the product.

4. The method of claim 1, wherein evaluating the authentication information comprises:
rating the authentication information based on an experience level associated with a user.

5. The method of claim 1, further comprising:
receiving the authentication information associated with the product from one or more users; and
collecting the authentication information from the one or more users.

6. A computer-implemented method, comprising:
receiving an identification of an RFID tag from a mobile device, wherein the identification of an RFID tag is received by a scan of the RFID tag by the mobile device;
identifying a product associated with the identification;
identifying a keeper associated with the product;
providing the keeper to the mobile device;
receiving a selection of the keeper from the mobile device;
identifying authentication information associated with the product and the keeper; and
providing the authentication information to the mobile device.

7. The method of claim 6, wherein the keeper is one of a merchant that sells the product or a merchant that stores the product.

8. The method of claim 6, wherein the authentication information includes whether the product is genuine or counterfeit.

9. The method of claim 6, wherein receiving a selection of the keeper from the mobile device comprises:
receiving confirmation that the keeper is associated with the product.

10. The method of claim 6, wherein identifying authentication information associated with the product and the keeper comprises:
identifying the authentication information based on previously collected authentication information associated with the product and the keeper.

11. A computer-implemented method, comprising:
receiving an identification of an RFID tag associated with a product;
providing the identification to a product authentication system;
receiving a keeper associated with the product based on the identification, wherein the keeper is one of a merchant that sells the product or a merchant that stores the product;
in response to receiving the keeper, receiving a selection of authentication information associated with the product; and
providing the authentication information associated with the product to the product authentication system.

12. The method of claim 11, wherein receiving the identification of the RFID tag associated with the product comprises:
scanning the identification of the RFID tag associated with the product.

13. The method of claim 11, wherein the identification of an RFID tag is received by a scan of the RFID tag by the mobile device.

14. The method of claim 11, wherein the authentication information includes whether the product is genuine or counterfeit.

15. A computer-implemented method, comprising:
receiving an identification of an RFID tag associated with a product;
providing the identification to a product authentication system;
receiving a keeper associated with the product based on the identification; and
in response to receiving a selection of the keeper, receiving and displaying authentication information associated with the product.

16. The method of claim 15, wherein receiving the identification of the RFID tag associated with the product comprises:
scanning the identification of the RFID tag associated with the product.

17. The method of claim 15, wherein the keeper is one of a merchant that sells the product or a merchant that stores the product.

18. The method of claim 15, wherein the authentication information includes whether the product is genuine or counterfeit.

19. A system, comprising:
a mobile device that receives an identification of an RFID tag associated with a product, provides the identification to an identification engine, receives a keeper associated with the product based on the identification, and in response to receiving the keeper, receives a selection of authentication information associated with the product, and provides the authentication information associated with the product to the product authentication engine; and
an identification engine that receives the identification, identifies the keeper associated with the product, provides the keeper to the mobile device, receives the authentication information associated with the product from the mobile device, associates the authentication information with the product and the keeper, and evaluates the authentication information.
